(19) United States
(12) Patent Application Publication
(10) Pub. No.: US 2013/0297405 A1
(43) Pub. Date: Nov. 7, 2013

(54) TIME SLICING IN ONLINE ADVERTISING EXPERIMENTATION

(71) Applicants: Ayman Farahat, San Francisco, CA (US); Tarun Bhatia, Simi Valley, CA (US); Eric Bax, Altadena, CA (US)

(72) Inventors: Ayman Farahat, San Francisco, CA (US); Tarun Bhatia, Simi Valley, CA (US); Eric Bax, Altadena, CA (US)

(73) Assignee: Yahoo! Inc., Sunnyvale, CA (US)

(21) Appl. No.: 13/462,976

(22) Filed: May 3, 2012

(51) Int. Cl. G06Q 30/02

(52) U.S. Cl. 705/14.43

(57) ABSTRACT

Techniques are provided that can be used in experimentation in online advertising. In an experiment, a short, recurring time interval during a period may be divided into a set of segments. Serving opportunities to users occurring during each of the segments may be associated with a particular specified experimental treatment. The short duration of the interval and segments may aid in reducing experimental bias by reducing variation in non-experimental variables between different treatment groups. User behavior following experimental treatment may be tracked and utilized in measurement of user response associated with the treatment. Results of the experiment may be utilized in optimizing aspects of an online advertising campaign.

### BACKGROUND

In online advertising, typically, advertisers buy media impressions in guaranteed and non-guaranteed marketplaces. Guaranteed marketplaces may facilitate publishers or their representatives pre-selling opportunities to advertise to advertisers or their representatives. In guaranteed marketplaces, advertisers may specify constraints on the advertising opportunities, which may include constraints on the demographics of the user who will see the ad or constraints on the type of content on the Web page where the ad will appear. These constraints may be part of targeting. Non-guaranteed marketplaces may perform auctions, where an advertiser may specify targeting, payment type (e.g., pay for impressions, clicks, or conversions), the bid (e.g., maximum amount willing to pay), and a periodic budget constraint.

To optimize aspects of an advertising campaign, for example, it is important to experiment. However, optimizing such experimentation, for example, can be challenging.

### SUMMARY

Some embodiments of the invention provide systems and methods for use in experimentation in online advertising. In an experiment, a short, recurring time interval during a period may be divided into a set of segments. Serving opportunities to users occurring during each of the segments may be associated with a particular specified experimental treatment. The short duration of the interval and segments may aid in reducing experimental bias by reducing variation in non-experimental variables between different treatment groups. User behavior following experimental treatment may be tracked and utilized in measurement of user response associated with the treatment. Results of the experiment may be utilized in optimizing aspects of an online advertising campaign.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

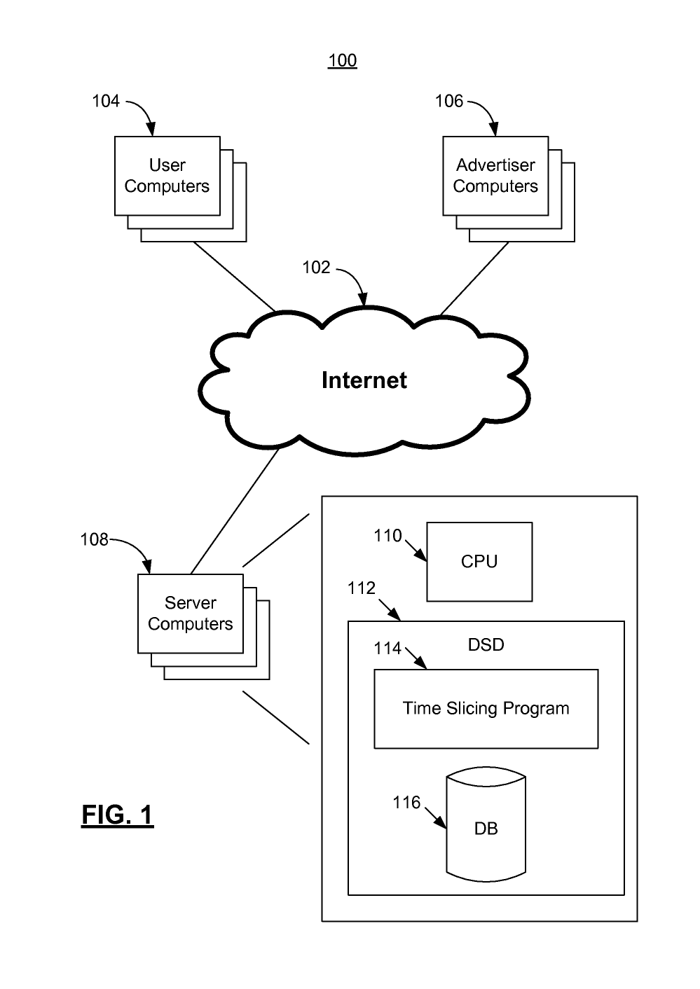

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and Time Slicing Program 114.

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices.

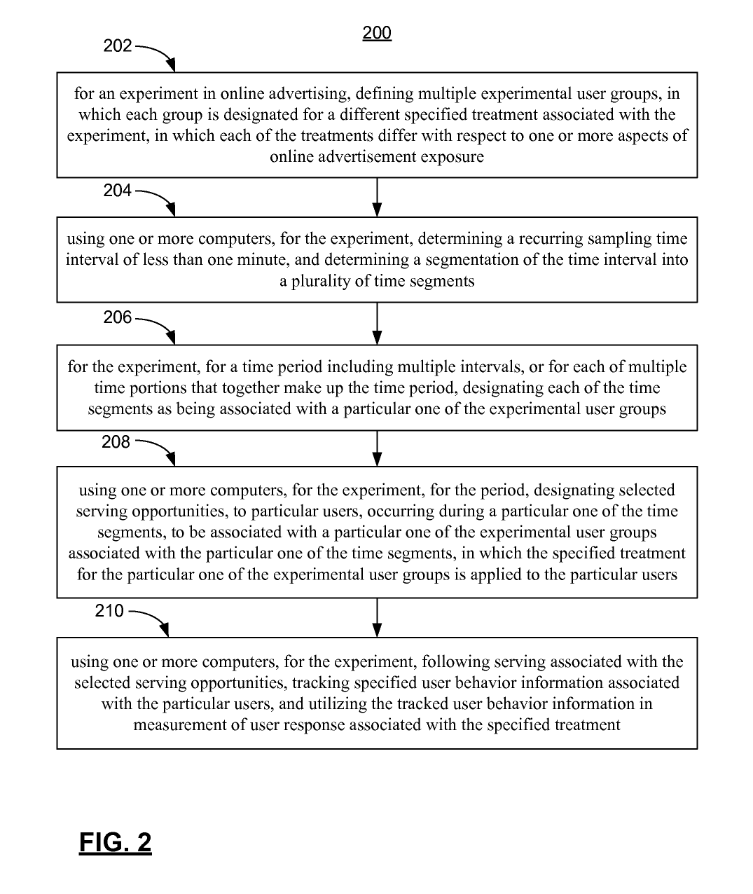

FIG. 2 is a flow diagram illustrating a method 200 according to one embodiment of the invention.

Step 202 includes, for an experiment in online advertising, defining multiple experimental user groups, in which each group is designated for a different specified treatment associated with the experiment, in which each of the treatments differ with respect to one or more aspects of online advertisement exposure.

Step 204 includes, using one or more computers, for the experiment, determining a recurring sampling time interval of less than one minute, and determining a segmentation of the time interval into a plurality of time segments.

Step 206 includes, for the experiment, for a time period including multiple intervals, or for each of multiple time portions that together make up the time period, designating each of the time segments as being associated with a particular one of the experimental user groups.

Step 208 includes, using one or more computers, for the experiment, for the period, designating selected serving opportunities, to particular users, occurring during a particular one of the time segments, to be associated with a particular one of the experimental user groups associated with the particular one of the time segments, in which the specified treatment for the particular one of the experimental user groups is applied to the particular users.

Step 210 includes, using one or more computers, for the experiment, following serving associated with the selected serving opportunities, tracking specified user behavior information associated with the particular users, and utilizing the tracked user behavior information in measurement of user response associated with the specified treatment.

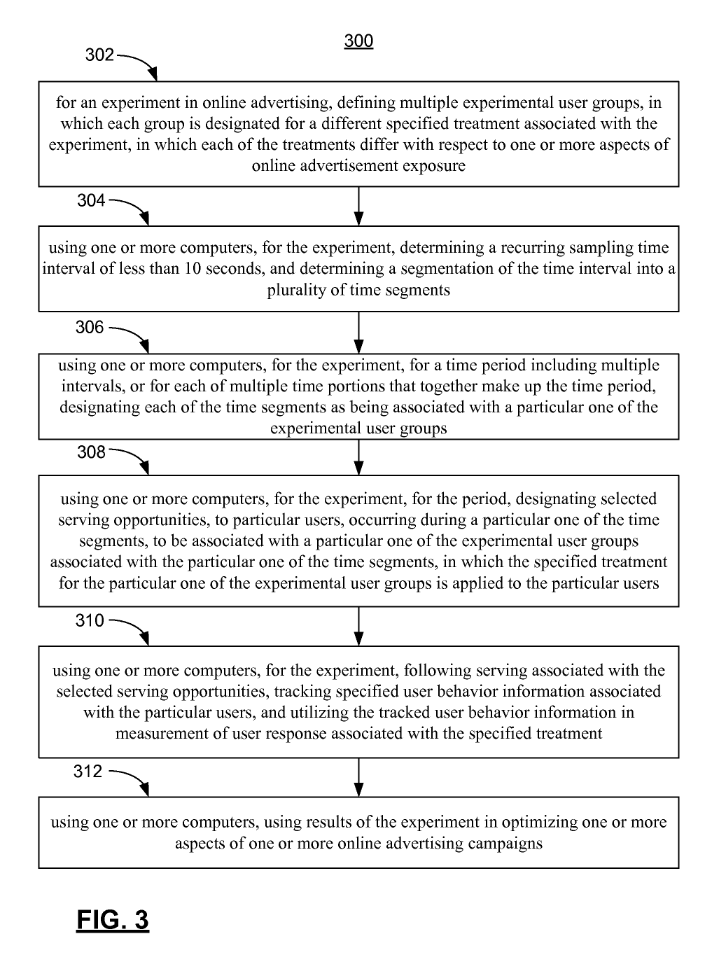

FIG. 3 is a flow diagram illustrating a method 300 according to one embodiment of the invention.

Step 302 includes, for an experiment in online advertising, defining multiple experimental user groups, in which each group is designated for a different specified treatment associated with the experiment, in which each of the treatments differ with respect to one or more aspects of online advertisement exposure.

Step 304 includes, using one or more computers, for the experiment, determining a recurring sampling time interval of less than 10 seconds, and including determining a segmentation of the time interval into a plurality of time segments.

Step 306 includes, for the experiment, for a time period including a plurality of the intervals, or for each of multiple time portions that together make up the time period, designating each of the time segments as being associated with a particular one of the experimental user groups.

Step 308 includes, using one or more computers, for the experiment, for the period, designating selected serving opportunities, to particular users, occurring during a particular one of the time segments, to be associated with a particular one of the experimental user groups associated with the particular one of the time segments, in which the specified treatment for the particular one of the experimental user groups is applied to the particular users.

Step 310 includes, using one or more computers, for the experiment, following serving associated with the selected serving opportunities, tracking specified user behavior information associated with the particular users, and utilizing the tracked user behavior information in measurement of user response associated with the specified treatment.

Step 312 includes, using one or more computers, using results of the experiment in optimizing one or more aspects of one or more online advertising campaigns.

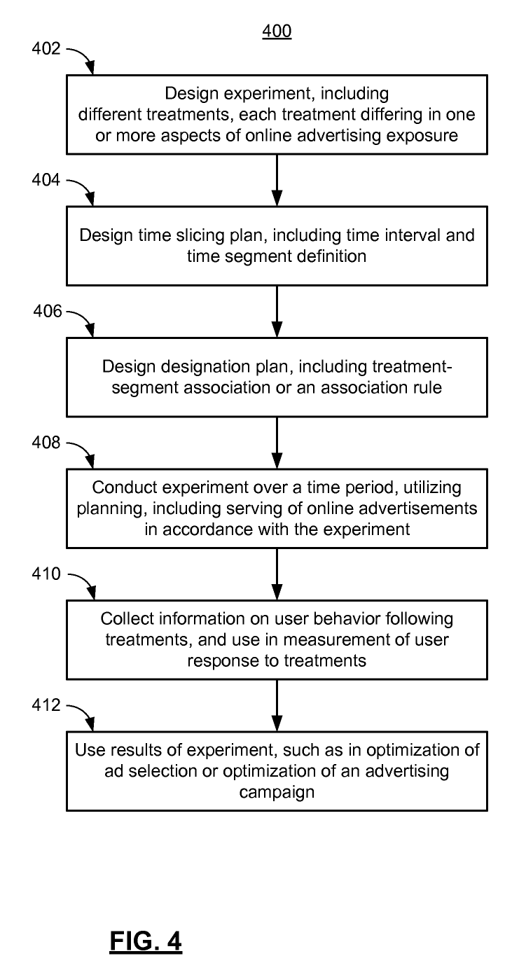

FIG. 4 is a block diagram 400 illustrating one embodiment of the invention. Block 402 represents design of an experiment, including different treatments (which can include experimental treatments and controls), each treatment differing in one or more aspects of online advertising exposure.

Block 404 represents design of a time slicing plan, including time interval and time segment designation.

Block 406 represents design of a designation plan, including treatment-segment association or an association rule. Note that the plan can be simple, in which each segment corresponds to a treatment. For example, every even second (or portion of a second) can correspond to one treatment, every odd second to a different treatment. Another simple example is that for an interval of N segments, each segment can be associated with one of N treatments, or this can randomized and varied, such as between intervals.

Many complex variations are of course possible. For example, randomization could be used to vary or change the segment-treatment associations during a time period. Furthermore, many experiments and different sets of treatments could be run concurrently, during the same time period.

Furthermore, more complex variations could include, for example, cycling between different treatment-segment correlations, or other variations. Still other more complex experimental schemes are contemplated. For example, in some embodiments, combinatorial design techniques may be utilized, such in determining combinations for particular treatments, or analysis of variance (ANOVA) or other techniques may be utilized, etc.

Block 408 represents conducting of an experiment over a time period, utilizing the planning, including serving (or preventing serving) of online advertisements in accordance with the experiment.

Block 410 represents collection of information on user behavior following treatments, and use of that information in measurement of user response to treatments. This can include both positive and negative response information, and response to non-exposure, exposure, exposure to particular variations, etc. As a simple example, response information can include frequency of click through following exposure to an ad, or can include frequency of some conversion following exposure versus frequency of conversion following non-exposure, etc.

Block 412 represents use of the results of the experiment, such as, for example, in optimization of advertisement selection, or optimization of one or more aspects of an advertising campaign.

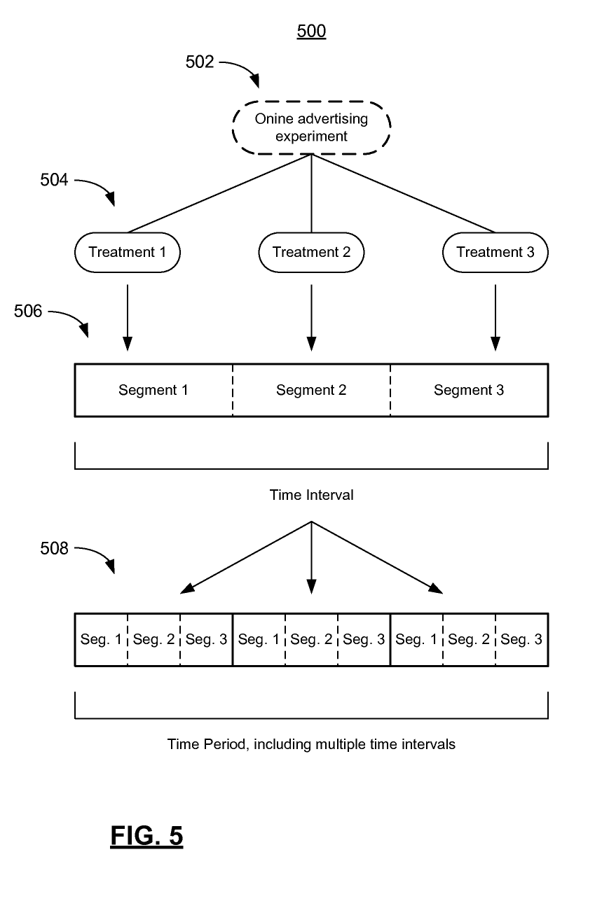

FIG. 5 is a block diagram 500 illustrating one embodiment of the invention. An online advertising experiment 502 is conceptually depicted, including multiple specified treatments 504. A time interval 506 is defined, which may, for example, be on the order of minutes, seconds, or portions of a second, and multiple time segments within the time interval are also defined. An experimental period, or a portion thereof, may be defined to run over a particular time period 508, which may include multiple recurring time intervals, each with multiple segments.

As depicted, as a simple example, each treatment is associated with a particular segment. This may mean, for example, that serving opportunities or ad calls to users occurring during a particular recurring segment, such as the first segment in a recurring interval, may be designated as associated with a particular treatment, which may mean that the treatment is applied to served users.

Experiments can be useful in online advertising. As just one of many examples, new targeting or bidding strategies could be tested alongside a control strategy to observe difference in performance. However, it can be that, for difference to be well attributed to the treatment, care must be taken that the strategies were tested in sufficiently similar or identical conditions, such as of supply and demand. This last condition is often ignored and may not be easily corrected later on. Instead, it can be better to, for example, design experiments up front that maintain sufficiently similar or identical conditions for control and treatment strategies, then randomly assign impressions to one or the other, and observe the performance. Some embodiments provide such techniques. It should be realized that performance in this case could be any number of relevant criteria, such as, for example, the volume of impressions won in an auction for different values of a bid (supply curve), the effect of a new strategy that resolves bids with real-time information, the value of new data fields in computing smarter bids, etc.

Experimentation may be useful or required when determining, for example, causal effects of a treatment. Naive observations of a control and treated population may suffer from selection bias, unless the assignment to treatment or control groups is randomized. Selection bias may creep in, which in many cases can obfuscate the true effects of the treatment and lead to mis-attributions. It may be up to publishing networks, for example, to select the ads to show for an impression, to enable experimentation capabilities that provide superior insights for advertisers. Another issue is that concurrent experimental treatment lines should ideally not compete with each other. As a result, partitioning finely on the time dimension can help ensure this property, and random assignment can further enable experiments. Alternatively, in some embodiments, to determine interactions among different possible changes to targeting and bidding, different combinations of possible changes can be tested, for example, by composing a factorial design for an experiment, then assigning time slices to the treatments from the design.

In a simple case of non-guaranteed buying, this may ideally require an advertiser or other party to run a control and treatment line concurrently, and have each qualified impression for the lines assigned to be bid by one or the other completely randomly. The resulting performance, for each of the control and treatment lines, can then be compared with each other and the difference attributed to the treatment, which could represent or help provide, for example, a superior algorithm for bid determination, a richer data vector with fields that indicate real-time value, or a more frequent invocation of an older algorithm. In some embodiments, all such strategies could be tested, and the impact could be evaluated on any number of variables, such as impressions won, return on ad spend for conversions, etc.

Some embodiments provide solutions that employ a modification to the serving algorithm in the event that an experimental non-guaranteed campaign is qualified for the impression at hand. Experimentation may result in several concurrent lines very similar or identical in targeting and practically all other respects but the bid, for instance. In some embodiments, serving control flow must gather all qualified lines matching the impression presenting the opportunity, but recognize that more than one line may belong to a single experimental campaign. It may then determine a winner in the selection phase. In the event that an experimental campaign wins, it may randomly select from among the treatment and control lines.

The randomization scheme could follow many options. For example, one option is to provide a target distribution of exposure for each treatment line, and allow the serve to randomly pick a line in that proportion. Another is to split and map the time scale to lines. For example, in this case, an experimental campaign with a single treatment line may be selected if the timestamp of the ad call contains falls on an even second, and be given to the control otherwise, or vice versa. For multiple lines, a similar randomization scheme could be employed to slice the time dimension. By doing so, it may be ensured that the conditions that the treatment and control lines were exposed to in terms of supply, demand, competition, budgets consumed, or other are balanced. The difference in performance can then more confidently be attributed as a causal effect of the treatment.

Some embodiments can include a flow that may include the following elements, among others. During campaign setup, the advertiser (or agent for the advertiser) may identify a campaign as experimental. Further, the advertiser may identify the number of treatments to be tested. The advertiser may further configure each treatment line to apply the treatment (bid strategy invoked, bid level, data included, etc.). The advertiser may further configure the campaign, with targeting, flight times, budgets etc.

The ad server may, upon getting an opportunity, get matching lines and their bids. Further, when an experimental campaign matches, the ad server may submit the bid for the treatment line that was selected based on the randomization criteria (regardless of the bid amount). The entered bids may be used to rank the lines and select a winner. Log events generated as normal may provide aggregate performance data for each treatment line, that was randomly assigned to opportunities that were otherwise very similar or equal (being close in time). An example alternative approach for the server is to submit all bids for the treatment lines, randomly select one and silent the others (much like ghost ads) in the selection mechanism. This may allow for capturing additional details for all the lines, such as how many times they would have won and the gap between first and second prices had the line actually been selected.

Various embodiments of the invention can thus provide many advantages, solutions, etc. For example, some embodiments provide randomized assignment of treatment or control line for an experimental campaign in a non-guaranteed auction setting for ad inventory. Furthermore, some embodiments provide a randomization scheme for the above that employs the timestamp, such that for high volume events, the treatment and control exposure is to impression populations that are practically identical, such as even and odd, or dividing by a prime number to assign to treatment buckets. Some embodiments allow controlling the extent of exposure of treatment lines in coordination with the randomization scheme. Some embodiments allow collection of data from such randomized experiments to generate insights about the causal effects of campaign strategies (bidding, data employment, etc) in generating performance for the advertiser. Furthermore, some embodiments allow employment of the above for a marketplace operator to devise more efficient selection and ranking criteria for matching ads to impressions. Still further, some embodiments provide the ability to run multiple experiments for advertisers at the same time, without any loss of causal inference, or the ability to test several treatments concurrently for an advertiser's experimental campaign.

While the invention is described with reference to the above drawings, the drawings are intended to be illustrative, and the invention contemplates other embodiments within the spirit of the invention.

1. A method comprising:
for an experiment in online advertising, defining a plurality of experimental user groups, wherein each group is designated for a different specified treatment associated with the experiment, wherein each of the treatments differ with respect to one or more aspects of online advertisement exposure;
using one or more computers, for the experiment, determining a recurring sampling time interval of less than one minute, and determining a segmentation of the time interval into a plurality of time segments;
using one or more computers, for the experiment, for a time period comprising a plurality of the intervals, or for each of a plurality of time portions that together make up the time period, designating each of the time segments as being associated with a particular one of the experimental user groups;
using one or more computers, for the experiment, for the period, designating selected serving opportunities, to particular users, occurring during a particular one of the time segments, to be associated with a particular one of the experimental user groups associated with the particular one of the time segments, wherein the specified treatment for the particular one of the experimental user groups is applied to the particular users; and
using one or more computers, for the experiment, following serving associated with the selected serving opportunities, tracking specified user behavior information associated with the particular users, and utilizing the tracked user behavior information in measurement of user response associated with the specified treatment.

2. The method of claim 1, wherein designating each of the time segments, for each of the intervals of the period, as being associated with a particular one of the experimental user groups comprises utilizing a randomization scheme.

3. The method of claim 1, wherein designating each of the time segments, for each of the intervals of the period, as being associated with a particular one of the experimental user groups comprises utilizing a randomization scheme, and wherein segment-user group and segment-treatment associations may change during the time period.

4. The method of claim 1, wherein the different specified treatments include one or more experimental treatments and one or more controls.

5. The method of claim 1, wherein the one or more aspects of online advertisement exposure can include exposure or non-exposure to a particular advertisement or type of advertisement.

6. The method of claim 1, wherein the one or more aspects of online advertisement exposure can include exposure to variations of a particular advertisement or type of advertisement.

7. The method of claim 1, comprising using results of the experiment in optimizing one or more aspects of online advertising.

8. The method of claim 1, wherein the experiment comprises utilizing combinatorial design in defining treatments.

9. The method of claim 1, comprising conducting the experiment, wherein the experiment is a bucket testing experiment, and wherein different time segments are associated with different buckets.

10. The method of claim 1, comprising conducting the experiment, wherein the experiment is a randomized experiment.

11. The method of claim 1, comprising conducting the experiment, wherein the experiment is an experiment in non-guaranteed delivery online advertising.

12. The method of claim 1, comprising conducting the experiment, wherein the recurring time interval is less than 10 seconds.

13. The method of claim 1, comprising conducting the experiment, wherein the recurring time interval is less than 1 second.

14. The method claim 1, comprising conducting the experiment, wherein the shortness of the duration of the interval reduces experimental bias relative to longer intervals.

15. The method claim 1, comprising conducting the experiment, wherein the shortness of the duration of the interval reduces variation in non-experimental variables relative to longer intervals.

16. A system comprising:
one or more server computers coupled to a network; and
one or more databases coupled to the one or more server computers;
wherein the one or more server computers are for:
for an experiment in online advertising, defining a plurality of experimental user groups, wherein each group is designated for a different specified treatment associated with the experiment, wherein each of the treatments differ with respect to one or more aspects of online advertisement exposure;
for the experiment, determining a recurring sampling time interval of less than one minute, and determining a segmentation of the time interval into a plurality of time segments;
for the experiment, for a time period comprising a plurality of the intervals, or for each of a plurality of time portions that together make up the time period, designating each of the time segments as being associated with a particular one of the experimental user groups;
for the experiment, for the period, designating selected serving opportunities, to particular users, occurring during a particular one of the time segments, to be associated with a particular one of the experimental user groups associated with the particular one of the time segments, wherein the specified treatment for the particular one of the experimental user groups is applied to the particular users; and
for the experiment, following serving associated with the selected serving opportunities, tracking specified user behavior information associated with the particular users, and utilizing the tracked user behavior information in measurement of user response associated with the specified treatment.

17. The system of claim 16, wherein at least one of the one or more server computers are coupled to the Internet.

18. The system of claim 16, wherein the different specified treatments include one or more experimental treatments and one or more controls.

19. The system of claim 16, wherein the one or more aspects of online advertisement exposure can include exposure or non-exposure to a particular advertisement or type of advertisement.

20. A computer readable medium or media containing instructions for executing a method comprising:
for an experiment in online advertising, defining a plurality of experimental user groups, wherein each group is designated for a different specified treatment associated with the experiment, wherein each of the treatments differ with respect to one or more aspects of online advertisement exposure;
using one or more computers, for the experiment, determining a recurring sampling time interval of less than 10 seconds, and determining a segmentation of the time interval into a plurality of time segments;
using one or more computers, for the experiment, for a time period comprising a plurality of the intervals, or for each of a plurality of time portions that together make up the time period, designating each of the time segments as being associated with a particular one of the experimental user groups;
using one or more computers, for the experiment, for the period, designating selected serving opportunities, to particular users, occurring during a particular one of the time segments, to be associated with a particular one of the experimental user groups associated with the particular one of the time segments, wherein the specified treatment for the particular one of the experimental user groups is applied to the particular users;
using one or more computers, for the experiment, following serving associated with the selected serving opportunities, tracking specified user behavior information associated with the particular users, and utilizing the tracked user behavior information in measurement of user response associated with the specified treatment; and
using one or more computers, using results of the experiment in optimizing one or more aspects of one or more online advertising campaigns.
